(19) United States
(12) Patent Application Publication
(10) Pub. No.: US 2022/0278569 A1
(43) Pub. Date: Sep. 1, 2022

(54) ROTATING ELECTRICAL MACHINE

(71) Applicant: KOGAKUIN UNIVERSITY, Tokyo (JP)

(72) Inventor: Mimpei Morishita, Tokyo (JP)

(21) Appl. No.: 17/638,749

(22) PCT Filed: Aug. 26, 2020
(86) PCT No.: PCT/JP2020/032248

§ 371 Date: Feb. 25, 2022

(30) Foreign Application Priority Data
Aug. 28, 2019 (JP) 2019-155987

(51) Int. Cl. H02K 1/27; H02K 21/14

(52) U.S. Cl. CPC H02K 1/27; H02K 21/14

(57) ABSTRACT

A field portion of a rotor of an electric motor includes plural permanent magnets arranged in a circumferential direction with magnetization directions thereof changing in steps of a predetermined angle. A stator is disposed at a radial direction outer side of the field portion. At the stator, three-phase coils of an armature are arranged in the circumferential direction at an inner periphery face of an annular outer cylinder. A ferromagnetic material is used in the outer cylinder, such that magnetic flux density in a magnetic field from the field portion is at least a residual magnetic flux density. A thickness dimension of the outer cylinder is set such that magnetic saturation is caused by the field portion. Consequently, an outer diameter of the stator may be reduced while torque ripple due to the magnet arrangement of the field portion is suppressed, and power output density may be improved.

### TECHNICAL FIELD

The present invention relates to a rotating electrical machine such as an electric motor, a generator or the like.

### BACKGROUND ART

A field system in which north and south poles of permanent magnets are alternatingly arrayed (an N-S array field system) is used in an electric motor, a generator or the like. A magnetic field at one side (a radial direction inner side or outer side) of the arrayed permanent magnets of this field system is used, but an N-S array field system generates the magnetic field at both sides of the arrayed permanent magnets. Thus, the magnetic field (magnetic energy from the permanent magnets) is not utilized effectively.

Permanent magnet array field systems include a Halbach array field system, in which plural permanent magnets are arrayed with the directions of the magnetic poles (magnetization directions) being successively turned in steps of, for example, 90°. In a Halbach array field system, a magnetic field may be produced that is stronger at one side than the other side in a direction crossing the array direction of the permanent magnets. Thus, the magnetic field generated by the permanent magnets may be utilized effectively.

Japanese Patent Application Laid-Open (JP-A) Nos. 2009-201343 and 2010-154688, etc. propose field systems (dual Halbach array field systems) in which two Halbach magnet arrays are disposed to oppose one another such that the magnetic fields mutually reinforce one another and magnetic fields generated by the permanent magnets may be more effectively utilized.

### SUMMARY OF INVENTION

### Technical Problem

Using a Halbach array field system for a field system in an electric motor enables great suppression of harmonics at low rotary speeds, which is expected to provide high power output, increase efficiency and improve power output density. However, in an electric motor using a dual Halbach array field system, counter-electromotive forces increase as rotary speed rises. Therefore, a power source for driving an electric motor at high rotary speeds requires outputs of electric power (voltage) that will overcome counter-electromotive forces produced in the electric motor.

Moreover, in an electric motor requiring high rotary speeds, an armature coil is commonly used at the stator side. In an electric motor using a dual Halbach array field system, a double rotor structure is formed by an inner rotor and an outer rotor that each employ a Halbach array field system.

Therefore, each of the two rotors in the electric motor is a cantilever structure, the rotors are increased in size and the rotor structures are complex, causing concern that vibrations and noise will be produced at high rotary speeds. Furthermore, in an electric motor requiring high rotary speeds, heat extraction requirements of armature coils are high but, in an electric motor with a double rotor structure, heat extraction from the armature coils is troublesome. Thus, there is scope for improvement in improving power output density of an electric motor or the like.

The present invention has been devised in light of the circumstances described above, and an object of the present invention is to provide a rotating electrical machine that may improve power output density. Solution to Problem

To achieve the object described above, a rotating electrical machine according to a first aspect includes: a field portion including a plural number of permanent magnets arranged in a circumferential direction with magnetization directions thereof being successively changed in steps of an angle that is a full cycle of electrical angles divided by a division number n, the division number n being any one integer that is at least three; a ferromagnetic body that is formed in an annular shape opposing each of the permanent magnets of the field portion and is relatively rotatable with respect to the field portion, a radial direction dimension of the ferromagnetic body being a dimension such that a magnetic flux density in a magnetic field caused by the field portion that is at least a residual magnetic flux density is obtained and such that the magnetic flux density reaches a saturation magnetic flux density; and an armature in which three-phase coils are arranged in the circumferential direction at a face of the ferromagnetic body at the side thereof at which the field portion is disposed.

In the rotating electrical machine according to the first aspect, the plural permanent magnets at the field portion are arrayed in the circumferential direction and are formed in an annular shape. The division number n is any integer that is at least three, and the magnetization directions of the plural permanent magnets are changed one-by-one in steps of the angle that is a full cycle of electrical angles divided by the division number n. Thus, a Halbach magnet array is employed at the field portion. A cylinder body is formed in an annular shape of the ferromagnetic material and opposes each of the permanent magnets of the field portion, and the three-phase coils of the armature are arrayed in the circumferential direction at the face of the cylinder body that is at the side thereof at which the field portion is disposed. Consequently, magnetic paths are formed between the field portion and the cylinder body, and a magnetic field may be formed between the field portion and the cylinder body that resembles a magnetic field of a dual Halbach magnet array in which Halbach magnet arrays are in a pair.

In the rotating electrical machine according to the first aspect, the coils of the armature are air-core coils. The armature formed by the respective air-core coils is disposed between the field portion and the cylinder body. As a result, magnetic permeability in the coil region may be similar to the magnetic permeability of air. Therefore, a magnetic flux distribution formed between the field portion and the cylinder body (i.e., changes in the magnetic flux distribution along the circumferential direction) may have a sinusoidal form, harmonics may be suppressed, and torque ripple may be suppressed effectively. These three-phase coils may employ concentrated windings, and Litz wire may be employed for the windings of the coils.

A radial direction dimension of the cylinder body using the ferromagnetic material is configured such that: a magnetic flux density obtained in the magnetic field caused by the field portion is at least the residual magnetic flux density, and a maximum magnetic flux density is the saturation magnetic flux density. If the radial direction dimension of the cylinder body is relatively large, the maximum magnetic flux density may not reach the saturation magnetic flux density. However, because the radial direction dimension of the cylinder body is a dimension such that the maximum magnetic flux density reaches the saturation magnetic flux density, the radial direction dimension may be reduced.

In this structure, a similar magnetic field to a dual Halbach magnet array may be formed by the field portion and cylinder body, overall power output may be improved, and the radial direction dimension of the cylinder body using the ferromagnetic material may be reduced. Therefore, the rotating electrical machine may be reduced in size and power output density may be improved.

In a rotating electrical machine according to a second aspect, in the first aspect, the field portion is provided at a rotor, and the cylinder body serves as a stator and surrounds an outer periphery of the field portion.

In the rotating electrical machine according to the second aspect, the cylinder body using the ferromagnetic material serves as the stator, and the stator is disposed at the radial direction outer side of the field portion that serves as the rotor. Because the outer diameter of the stator may be reduced, the power output density may be improved effectively.

In a rotating electrical machine according to a third aspect, in the first aspect or the second aspect, a radial direction dimension of the cylinder body is set to a maximum dimension at which the magnetic flux density is the saturation magnetic flux density.

In the rotating electrical machine according to the third aspect, the radial direction dimension of the cylinder body is the maximum dimension at which magnetic flux density becomes the saturation magnetic flux density. Therefore, magnetic resistance caused by magnetic saturation in the cylinder body may be suppressed, and a reduction in power output resulting from magnetic saturation may be suppressed.

In a rotating electrical machine according to a fourth aspect, in any one of the first to third aspects, a magnetic pole number P of the field portion and a slot number S are specified such that a number of magnetic flux interlinkage of fifth spatial harmonics of the coils is smaller than a number of magnetic flux interlinkage of the fifth spatial harmonics in a case in which the magnetic pole number P is two thirds of the slot number S, the slot number S being a number of the coils of the armature.

In the rotating electrical machine according to the fourth aspect, the magnetic pole number P of the field portion and the slot number S that is the number of coils in the armature are specified such that the number of magnetic flux interlinkage of the fifth spatial harmonics of the coils is smaller than the number of magnetic flux interlinkage of the fifth spatial harmonics would be if the magnetic pole number P were two thirds of the slot number S. In other words, the slot number S of the armature is set to a value other than three per two of the magnetic pole number P of the field portion.

In the magnetic field between the field portion and the cylinder body, the amplitudes of fifth spatial harmonics of three-phase AC electric power are large and influence torque ripple. In particular, torque ripple caused by spatial harmonics is largest when the magnetic pole number P is two thirds of the slot number S. Therefore, the number of magnetic flux interlinkage of the fifth spatial harmonics of the coils may be reduced effectively by setting the slot number S to a value other than three per two of the magnetic pole number P, and thus torque ripple may be suppressed effectively.

In a rotating electrical machine according to a fifth aspect, in any one of the first to fourth aspects, the division number n is a number obtained by adding 2 to a multiple of 3.

In the rotating electrical machine according to the fifth aspect, the division number n is set to any number that is a multiple of 3 plus 2. Consequently, the fifth harmonics may be suppressed, and torque ripple caused by magnetic saturation in the cylinder body may be suppressed effectively.

In a rotating electrical machine according to a sixth aspect, in any one of the first to fifth aspects, a gap length that is a spacing between a periphery face of the field portion and a periphery face of the cylinder body is at least 0.25 times and at most 1.0 times a pole pitch τ of the permanent magnets of the field portion.

In the rotating electrical machine according to the sixth aspect, the gap length that is the spacing between the periphery face of the field portion and the periphery face of the cylinder body is not less than 0.25 times and not more than 1.0 times the pole pitch τ according to the permanent magnets of the field portion. Consequently, a magnetic field resembling a magnetic field caused by a dual Halbach array field system may be formed effectively between the field portion and the cylinder body.

### Advantageous Effects of Invention

According to a rotating electrical machine according to the present aspects as described above, an excellent effect is provided in that, because a reduction in power output may be suppressed and size may be reduced, power output density may be improved.

### BRIEF DESCRIPTION OF DRAWINGS

FIG. 1 is a schematic diagram showing principal portions of an electric motor according to a present exemplary embodiment.

FIG. 2 is a schematic diagram showing a Halbach magnet array.

FIG. 3A is a schematic structural diagram showing a field system that employs a cylinder body using a ferromagnetic material for one of two Halbach magnet arrays.

FIG. 3B is a schematic structural diagram showing a Halbach array field system in which two Halbach magnet arrays are opposed.

FIG. 4A is a plan view showing schematic structures of principal portions of an electric motor.

FIG. 4B is a plan view showing schematic structures of a field portion corresponding to a dual Halbach array field system.

FIG. 5A is a schematic diagram showing a distribution of magnetic force lines and magnetic density between a field portion and an outer cylinder portion when a thickness dimension ly of the outer cylinder portion is greater than lys.

FIG. 5B is a schematic diagram showing a distribution of magnetic force lines and magnetic density between the field portion and an outer cylinder portion when the thickness dimension ly of the outer cylinder portion is equal to lys.

FIG. 5C is a schematic diagram showing a distribution of magnetic force lines and magnetic density between the field portion and an outer cylinder portion when the thickness dimension ly of the outer cylinder portion is less than lys.

FIG. 6A is a schematic diagram of principal portions of an electric motor, showing an example of a slot number relative to a magnetic pole number.

FIG. 6B is a schematic diagram of principal portions of an electric motor, showing another example of the slot number relative to the magnetic pole number.

FIG. 7A is a schematic wiring diagram showing an example of connections of coils.

FIG. 7B is a schematic wiring diagram showing another example of connections of the coils.

FIG. 8 is a graph schematically showing changes in numbers of magnetic flux interlinkage of fifth spatial harmonics interlinking with the coils in combinations of P and S.

### DESCRIPTION OF EMBODIMENTS

Below, an exemplary embodiment of the present invention is described in detail with reference to the attached drawings. The present exemplary embodiment incorporates the following measures.

<1>A rotating electrical machine including:

a field portion including plural permanent magnets arranged in an annular shape in a circumferential direction with magnetization directions thereof being successively changed by an angle that is a full cycle of electrical angles divided by a division number n, the division number n being any one integer that is at least three;

a cylinder body that is formed in an annular shape opposing each of the permanent magnets and is relatively rotatable with respect to the field portion, a ferromagnetic material being used in the cylinder body, a central axis of the cylinder body coinciding with a central axis of the field portion, and a radial direction dimension of the cylinder body being a dimension such that magnetic flux density obtained in a magnetic field caused by the field portion is at least a residual magnetic flux density, and the magnetic flux density reaches a saturation magnetic flux density; and

an armature in which three-phase coils are arranged in the circumferential direction at a face of the cylinder body at the side thereof at which the field portion is disposed, each coil being an air-core coil.

<2>A rotating electrical machine including:

a field portion including plural permanent magnets arranged in an annular shape in a circumferential direction with magnetization directions thereof being successively changed by an angle that is a full cycle of electrical angles divided by a division number n, the division number n being any one integer that is at least three;

a cylinder body that is formed in an annular shape opposing each of the permanent magnets and is relatively rotatable with respect to the field portion, a ferromagnetic material being used in the cylinder body, a central axis of the cylinder body coinciding with a central axis of the field portion, and a radial direction dimension of the cylinder body being a dimension such that magnetic flux density obtained in a magnetic field caused by the field portion is at least a residual magnetic flux density, and the magnetic flux density reaches a saturation magnetic flux density; and

an armature in which three-phase coils are arranged in the circumferential direction at a face of the cylinder body at the side thereof at which the field portion is disposed, each coil being an air-core coil,

wherein a periphery face of the cylinder body at the side thereof at which the field portion is disposed is disposed at a position that would be a central position between the field portion and another field portion forming a pair with the field portion if the another field portion forming the pair with the field portion were disposed at the side of the field portion at which the cylinder body is disposed and changes in magnetic flux density in the circumferential direction were in a sinusoidal form.

<3>In <1>or <2>, a dimension of the cylinder body is configured such that: a magnetic flux density obtained in the magnetic field caused by the field portion is at least a residual magnetic flux density, the residual magnetic flux density being a magnetic flux density of the permanent magnets in a case in which an air gap length between a surface opposing the field portion and a surface of the field portion is zero, and with a predetermined air gap length, the magnetic flux density reaches the saturation magnetic flux density.

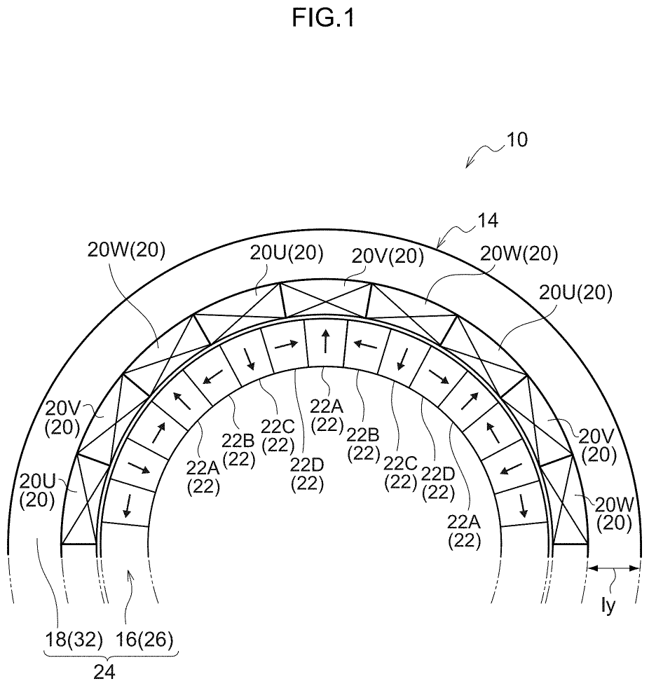

FIG. 1 shows, in a plan view seen in an axial direction, schematic structures of principal portions of a three-phase AC electric motor (below referred to as “the electric motor”) 10 that serves as a rotating electrical machine according to the present exemplary embodiment.

As shown in FIG. 1, the electric motor 10 is provided with a rotor 12 with a substantially cylindrical outer profile that serves as a rotor, and a stator 14 with a substantially cylindrical shape (an annular shape) that serves as a stator. In the electric motor 10, a central axis of the rotor 12 and the central axis of the stator 14 coincide, and the rotor 12 is relatively rotatably accommodated inside the stator 14.

A field portion 16 is provided at the rotor 12, at an outer periphery portion that is at the side of the rotor 12 at which the stator 14 is disposed. An outer cylinder portion 18 in a ring shape (an annular shape) and an armature 20 are provided at the stator 14. The outer cylinder portion 18 serves as a cylinder body at which a ferromagnetic material is used. The stator 14 is formed in a substantially cylindrical shape overall. The armature 20 is arranged in the circumferential direction at an inner periphery face of the stator 14, which is the face at the side thereof at which the field portion 16 of the outer cylinder portion 18 is disposed. Thus, in the electric motor 10, the armature 20 is opposed with the radial direction outer side of the field portion 16 of the rotor 12, the armature 20 is integral with the outer cylinder portion 18, and the armature 20 is relatively rotatable with respect to the field portion 16.

In the electric motor 10, a plural number of permanent magnets 22 are arranged in the circumferential direction at the field portion 16. In the electric motor 10, a magnetic field generating portion 24 that serves as a magnetic field generating device is constituted by the field portion 16 of the rotor 12 and the outer cylinder portion 18 of the stator 14. The magnetic field generating portion 24 forms a magnetic field (magnetic field) between the field portion 16 and the outer cylinder portion 18.

As three-phase coils that respectively structure the armature 20, U-phase coils 20U, V-phase coils 20V and W-phase coils 20W are provided in the electric motor 10. Each of the coils 20U, 20V and 20W (coils 20U to 20W) may employ Litz wire as windings. The coils 20U to 20W may respectively be air-core coils, and the coils 20U to 20W may respectively be formed as concentrated windings.

At the armature 20 of the electric motor 10, the coil 20U, coil 20V and coil 20W of the three phases form a set. Plural sets of the coils 20U to 20W are arranged in a predetermined sequence along the circumferential direction at the inner periphery face of the outer cylinder portion 18. AC electric power with a predetermined frequency is supplied to each set of the coils 20U to 20W of the electric motor 10 in three phases (the U phase, the V phase and the W phase) that are offset by 120° from one another in the range of a full cycle of electrical angles. As a result, the rotor 12 of the electric motor 10 is rotated at a rotary speed according to the frequency of the three-phase AC electric power being supplied to each of the plural sets of the coils 20U to 20W, and a power output shaft, which is not shown in the drawings, is driven to rotate integrally with the rotor 12.

Now, the field portion 16 of the rotor 12 and outer cylinder portion 18 of the stator 14 that form the magnetic field generating portion 24 of the electric motor 10 are described in more detail.

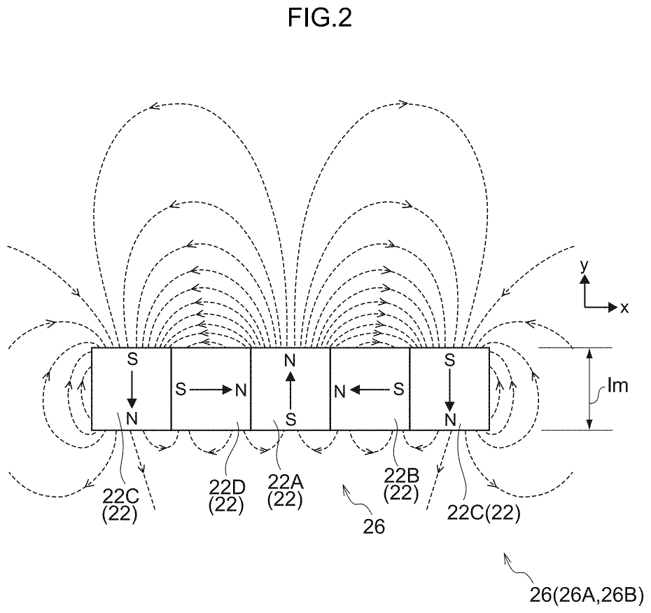

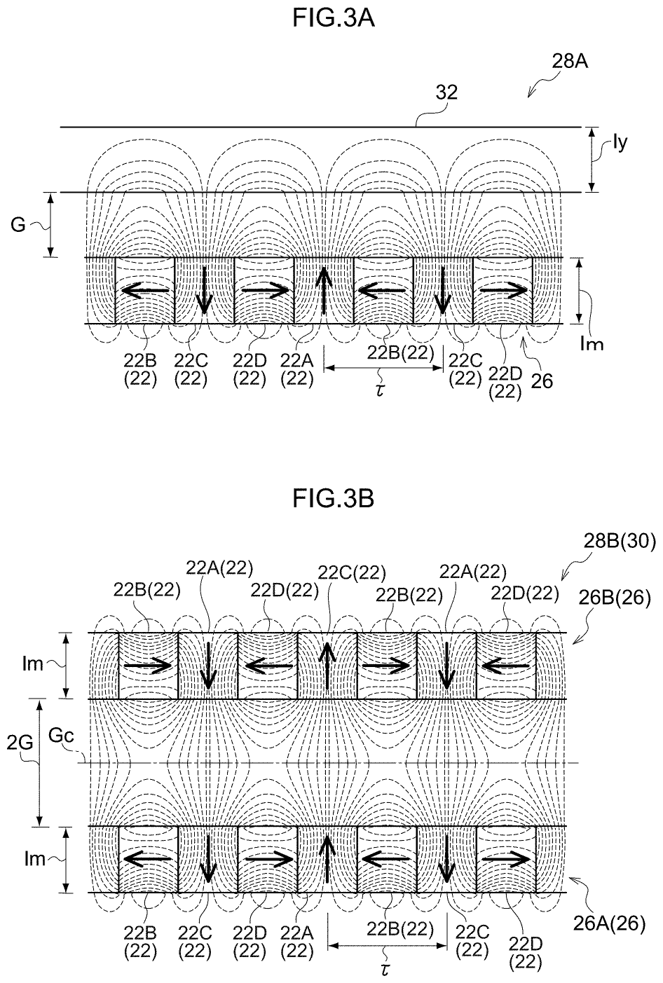

In the electric motor 10 (the magnetic field generating portion 24), a Halbach magnet array is employed at the field portion 16 of the rotor 12. FIG. 2 shows a schematic of a common Halbach magnet array in a plan view. FIG. 3A and FIG. 3B respectively show schematics of magnetic field generating portions (magnetic field generating devices) in which Halbach magnet arrays are employed in plan views. In the drawings, the north pole side of each permanent magnet 22 is indicated by the symbol N and the south pole side is indicated by the symbol S. In the descriptions below, the magnetization direction of each permanent magnet 22 is indicated by an arrow (a solid line arrow) from the south pole side toward the north pole side. Magnetic force lines are indicated by broken line arrows from the north pole side toward the south pole side (and from the south pole side toward the north pole side inside the permanent magnets 22). In the drawings, one direction that is an arrangement direction of the permanent magnets 22 is indicated by an arrow x, and a direction of magnetic force lines that contribute to generating torque at the Halbach magnet array is indicated by the arrow y.

As illustrated in FIG. 2, in a Halbach magnet array, for example, a cross section of each permanent magnet 22 cut along the magnetization direction is formed in a substantially rectangular shape (a substantially square shape, and in three dimensions, a substantially cuboid shape). A division number n and an angle θ (not shown in the drawings) according to the division number n are specified for the Halbach magnet array. Depending on the division number n, N of the permanent magnets 22 are successively arranged in a predetermined direction (the direction of arrow x) with the magnetization directions thereof being changed in steps of the predetermined angle θ. Thus, a single Halbach array field system 26 (below referred to simply as “the Halbach array field system 26”) is formed. The angle θ is the angle (not shown in the drawings) between the magnetization directions of two adjacent permanent magnets 22.

The division number n that is employed may be any integer that is at least three, and the angle θ that is employed is an angle obtained by dividing a full cycle of electrical angles (2π radians=360° divided by the division number n (the integer that is at least three). In the present exemplary embodiment, as an example, the division number n=4, and the angle θ=90° (θ=360°/4=90°.

In the Halbach array field system 26, permanent magnets 22A, 22B, 22C and 22D are successively arrayed with the magnetization directions thereof being changed in steps of 90° (and this arrangement of the permanent magnets 22A to 22D is repeated). The magnetization directions of the permanent magnets 22B and 22D at the two sides of the permanent magnet 22A are oriented towards the permanent magnet 22A. As a result, in the Halbach array field system 26, a magnetic field is stronger at one side in a direction crossing the array direction (the side in the magnetization direction of the permanent magnet 22A), and the strength of the magnetic field at the other side (the opposite side from the magnetization direction of the permanent magnet 22A) is suppressed.

FIG. 3A shows in a plan view, as an example, schematic structures of a magnetic field generating portion 28A employing one of the Halbach array field system 26 (a single Halbach array field system). FIG. 3B shows in a plan view, as another example, schematic structures of a dual Halbach array field system 30 that serves as a magnetic field generating portion 28B employing two of the Halbach array field system 26 (26A and 26B).

As shown in FIG. 3B, in the magnetic field generating portion 28B (the dual Halbach array field system 30), the Halbach array field system 26A and the other Halbach array field system 26B that forms a pair with the Halbach array field system 26A oppose one another, spaced apart by a predetermined spacing (a gap length 2G). More specifically, the dual Halbach array field system 30 is formed by the two Halbach array field systems 26 (26A and 26B) acting as a pair with the sides thereof at which the magnetic fields are stronger opposing one another.

Here, the permanent magnets 22A of one of the Halbach array field systems 26A and 26B structuring the dual Halbach array field system 30 (for example, the Halbach array field system 26A) oppose the permanent magnets 22C of the other (for example, the Halbach array field system 26B), which have the same magnetization directions. Namely, the Halbach array field system 26A and 26B could be described as a state in which the permanent magnet 22B and permanent magnet 22D at the two sides of each permanent magnet 22A are switched, in a state in which the magnetization directions of the permanent magnets 22A were the same as one another (and the permanent magnets 22C could be the same as one another).

Thus, in the dual Halbach array field system 30, a magnetic field is formed between the Halbach array field systems 26A and 26B arranged in a pair, which magnetic field is stronger than in a structure using only one of the Halbach array field system 26.

In relation to electric fields (in the field of electrostatics), the method of images (method of mirror charges) is known. Although not shown in the drawings, according to the method of images, electric force lines between positive and negative point charges of +q and −q that are opposed with a predetermined distance (spacing dimension) 2g therebetween have planar symmetry (in two dimensions, line symmetry). The plane of symmetry is at a position at distances g from the point charges +q and −q, which is a central position therebetween. From this situation, one of the point charges +q and −q (for example, the point charge −q) is replaced with a conductive body (a perfect conductor). A surface at the point charge +q side of the conductive body is disposed at the position the distance g from the point charge +q (i.e., the central position between the point charges +q and −q). Hence, according to the method of images, electric force lines between the point charge +q and the conductive body are the same as the electric force lines between the point charge +q and the central position (the position of the plane of symmetry) between the point charges +q and −q.

The method of images is applicable to magnetic fields (magnetic fields) similarly to electric fields, with a ferromagnetic body using a ferromagnetic material being employed in place of the conductive body. Accordingly, in FIG. 3A, a ferromagnetic body 32 is disposed in place of the other Halbach array field system 26B that is paired with the Halbach array field system 26A in the dual Halbach array field system 30. The ferromagnetic body 32 is formed of a ferromagnetic material. A surface of the ferromagnetic body 32 at the side thereof at which the Halbach array field system 26 is disposed is disposed at the position of a gap center Gc, which is a central position between the Halbach array field systems 26A and 26B.

Therefore, in the magnetic field generating portion 28A, the spacing between the Halbach array field system 26 and the ferromagnetic body 32, which is an air gap length, is a gap length G, in contrast to the gap length 2G that is the spacing between the Halbach array field systems 26A and 26B in the dual Halbach array field system 30. Hence, in the magnetic field generating portion 28A, a magnetic flux distribution between the Halbach array field system 26 and the ferromagnetic body 32 is the same as a magnetic flux distribution between the gap center Gc and the Halbach array field system 26A in the dual Halbach array field system 30.

As shown in FIG. 1, in the magnetic field generating portion 24 of the electric motor 10, a Halbach magnet array (corresponding to the Halbach array field system 26) is employed at the field portion 16 of the rotor 12, and a ferromagnetic material is used at the outer cylinder portion 18 of the stator 14 surrounding the field portion 16 (the outer cylinder portion 18 corresponds to the ferromagnetic body 32).

In the electric motor 10, a position of the inner periphery face of the outer cylinder portion 18 relative to the outer periphery face of the field portion 16 (the spacing between the outer periphery face of the field portion 16 and the inner periphery face of the outer cylinder portion 18) is set to a position corresponding to the gap center Gc of the dual Halbach array field system 30 (a position corresponding to the gap length G). That is, a surface of the outer cylinder portion 18 at the side thereof at which the field portion 16 is disposed is disposed at what would be a central position between the field portion 16 and another field portion forming a pair with the field portion 16 in a structure in which the another field portion was disposed at the side of the field portion 16 at which the outer cylinder portion 18 is disposed. Therefore, in the electric motor 10, a magnetic flux distribution between the field portion 16 and the outer cylinder portion 18 is the same as a magnetic flux distribution between the gap center Gc and the Halbach array field system 26A in the dual Halbach array field system 30.

Now, the gap length G of the electric motor 10 is described. The field portion 16 of the electric motor 10 is formed of a Halbach magnet array in which m sets of the permanent magnets 22A to 22D are used and the permanent magnets 22A to 22D are successively arrayed in the circumferential direction. As an example in the electric motor 10, eight sets of the permanent magnets 22A to 22D are used in the field portion 16 (m=8).

In the Halbach magnet array, N of the permanent magnets 22 are formed in sets according to the division number n. In the Halbach magnet array, in the array of the N permanent magnets 22 corresponds to dipoles of north and south, and the magnetic pole number P corresponds to the dipoles. Therefore, in the electric motor 10, 32 of the permanent magnets 22 are used in the eight sets of the permanent magnets 22A to 22D in the field portion 16, and the magnetic pole number P of the electric motor 10 is 16.

In the field portion 16 of the electric motor 10, the 32 permanent magnets 22 of the Halbach array field system 26 are arrayed in a cylindrical shape (an annular shape) by isometric deformation of a cross section cut along the magnetization direction of each of the permanent magnets 22.

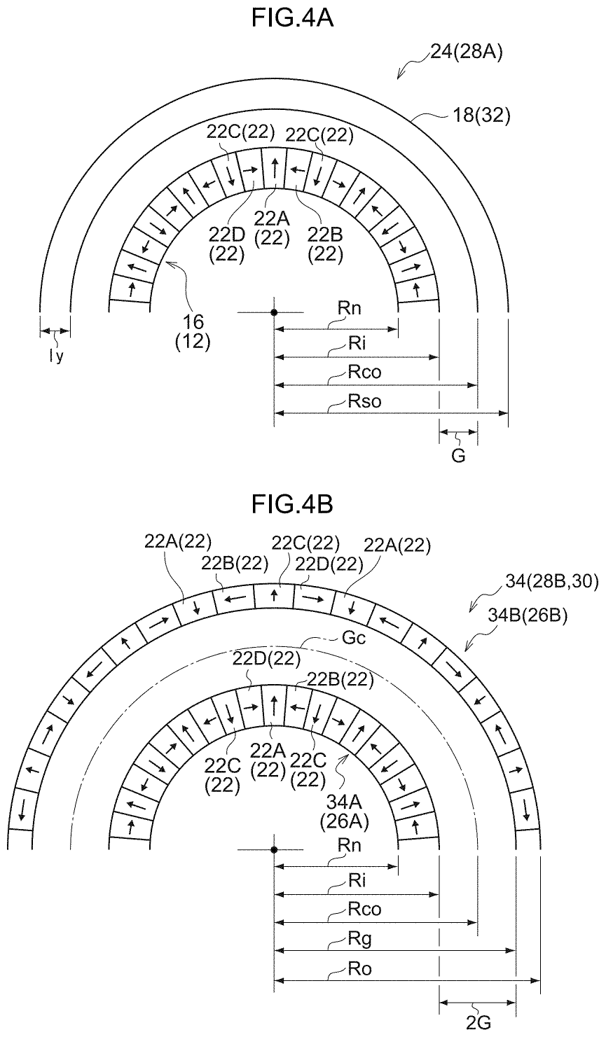

Now, Halbach magnet arrays in which the permanent magnets 22 are isometrically deformed are described with reference to FIG. 3A, FIG. 3B, FIG. 4A and FIG. 4B. FIG. 4A shows schematic structures of the magnetic field generating portion 24 of the electric motor 10 in a plan view seen in the axial direction, and FIG. 4B shows a magnetic field generating portion 34 employing a dual Halbach magnet array in a plan view seen in the axial direction. FIG. 4A corresponds to isometric deformation of FIG. 3A (the magnetic field generating portion 28A), and FIG. 4B corresponds to isometric deformation of FIG. 3B (the magnetic field generating portion 28B). For simplicity of description of FIG. 4A and FIG. 4B, the same reference symbols are applied to the permanent magnets 22 before and after isometric deformation.

As shown in FIG. 4B, the magnetic field generating portion 34 is formed by a radial direction inner side field portion 34A and a radial direction outer side field portion 34B. The field portions 34A and 34B are formed in cylindrical shapes (annular shapes) in which the respective permanent magnets 22 are arrayed in circular arc shapes. The field portion 34A of the magnetic field generating portion 34 corresponds to isometric deformation of the Halbach array field system 26A, and the field portion 34B corresponds to isometric deformation of the Halbach array field system 26B. Thus, the magnetic field generating portion 34 corresponds to isometric deformation of the dual Halbach array field system 30.

In an isometric deformation: αi represents a cross-sectional area ratio between a radial direction cross section of each permanent magnet 22 of the field portion 34A at the inner side and the same area before deformation; αo represents a cross-sectional area ratio between a radial direction cross section of each permanent magnet 22 of the field portion 34B at the outer side and the same area before deformation; Sg represents half of the radial direction cross-sectional area of each permanent magnet 22 in the field portion 34A and the field portion 34B; a represents a ratio of an area of a radial direction cross section of a gap relative to an average cross-sectional area of the permanent magnets 22 of the field portion 34A at the inner side and the permanent magnets 22 of the field portion 34B at the outer side; and lm represents the length of one side converted to the permanent magnet 22 before deformation (which is a cross-sectional square shape; see FIG. 2 and the like).

Variables Rh, Ri, Rco, Rso, Rg and Ro are specified as radial diameter dimensions (radii) of respective portions as shown in FIG. 4A and FIG. 4B. A division number of the permanent magnets 22 which is the total number of the permanent magnets 22 in each of the field portion 34A and the field portion 34B (an overall division number) is represented by Nm.

In the magnetic field generating portion 34 employing the dual Halbach magnet array, the following relationships (1) to (8) apply.

$${α}_{i} = \frac{2 ( π {R}_{c 0}^{2} - π {R}_{i}^{2} )}{{aS}_{g}} \qquad ( 1 )$$

$${α}_{o} = \frac{2 ( - π {R}_{c 0}^{2} - π {R}_{i}^{2} )}{{aS}_{g}} \qquad ( 2 )$$

$${α}_{i} {S}_{g} = - π {R}_{h}^{2} + π {R}_{i}^{2} \qquad ( 3 )$$

$${α}_{o} {S}_{g} = - π {R}_{g}^{2} + π {R}_{o}^{2} \qquad ( 4 )$$

$${aS}_{g} = π {R}_{g}^{2} - π {R}_{i}^{2} \qquad ( 5 )$$

$${R}_{c 0} = \frac{{R}_{g} + {R}_{i}}{2} \qquad ( 6 )$$

$${l}_{m} = \frac{2 π {R}_{c 0}}{{N}_{m}} \qquad ( 7 )$$

$${S}_{g} = {N}_{m} {l}_{m}^{2} \qquad ( 8 )$$

Therefore, for the variables lm, Ro, Ri and Rg of the magnetic field generating portion 34 (the field portions 34A and 34B) and the magnetic field generating portion 24 (the field portion 16 and the outer cylinder portion 18), the following relationships (9) to (13) apply.

$${l}_{m} = \frac{2 π {R}_{c 0}}{{N}_{m}} \qquad ( 9 )$$

$${R}_{o} = {R}_{c 0} \sqrt{\frac{{N}_{m}^{2} + 2 ( 2 + a ) {N}_{m} π + a ( 2 + a ) {π}^{2}}{{N}_{m}^{2}}} \qquad ( 10 )$$

$${R}_{i} = {R}_{c 0} - \frac{a π {R}_{c 0}}{{N}_{m}} \qquad ( 11 )$$

$${R}_{g} = {R}_{c 0} + \frac{a π {R}_{c 0}}{{N}_{m}} \qquad ( 12 )$$

$${R}_{h} = {R}_{c 0} \sqrt{\frac{{N}_{m}^{2} - 2 ( 2 + a ) {N}_{m} π + a ( 2 + a ) {π}^{2}}{{N}_{m}^{2}}} \qquad ( 13 )$$

In the magnetic field generating portion 34, the principal variables that can be set are Rco, Nm and a. Of these, a is a parameter for setting a maximum number of magnetic flux interlinking with respect to the total mass of the permanent magnets 22, and is set individually for electric motors in which the magnetic field generating portion 34 is used (electric motors employing the dual Halbach magnet array).

The position of the inner periphery face of the outer cylinder portion 18 relative to the field portion 16 in the magnetic field generating portion 24 of the electric motor 10 may be specified using values of the variables of the magnetic field generating portion 34 that are specified accordingly (principally, Rh, Ri and Rco). The gap length G between the field portion 16 and the outer cylinder portion 18 is provided by the following expression.

G=(Rco−Ri)=(Rg−Ri)/2

A pole pitch τ of the Halbach array field system 26 (26A and 26B) is obtained from the division number n and the length lm of the sides of each permanent magnet 22, as τ=(n·lm)/2. The pole pitch τ at the gap center Gc is obtained from the division number Nm that is the number of the permanent magnets 22 in the full circle of the magnetic field generating portion 34 and the radius Rco of the gap center Gc, as τ=(n·π·Rco)/Nm.

In the dual Halbach array field system 30, a gap length 2G that provides a maximum number of magnetic flux interlinkage at the gap center Gc is in a range from 0.5 times to 2.0 times the pole pitch τ (0.5τ≤2G≤2.0τ). Therefore, in the magnetic field generating portion 34 corresponding to the dual Halbach array field system 30, the gap length 2G specified by the relationships described above falls within the range from 0.5 times to 2.0 times the pole pitch τ.

Accordingly, the gap length G of the magnetic field generating portion 24 of the electric motor 10 may be set in a range from 0.25 times to 1.0 times τ (0.25τ≤G≤1.0τ).

A soft magnetic material such as magnetic steel plate or the like may be employed as a ferromagnetic body at the outer cylinder portion 18 (the ferromagnetic body 32). A radial direction dimension of the outer cylinder portion 18 is set so as to provide a magnetic flux density that is at least a residual magnetic flux density in the magnetic field of the field portion 16. A saturation magnetic flux density at the outer cylinder portion 18 is determined in accordance with a thickness dimension ly, which is the radial direction dimension.

The outer cylinder portion 18 employs a ferromagnetic material with a high magnetic permeability such that a magnetic flux density in the magnetic field produced by the field portion 16 is at least a residual magnetic flux density of the permanent magnets 22 if the gap length G that is the spacing distance between the surface opposing the field portion 16 and the surface of the field portion 16 were zero. The radial direction dimension of the outer cylinder portion 18 is set to a dimension such that the magnetic flux density with a predetermined gap length G reaches the saturation magnetic flux density.

In the electric motor 10, magnetic saturation of the outer cylinder portion 18 tends to cause torque ripple. Accordingly, substantially increasing the thickness dimension ly of the outer cylinder portion 18 in order to prevent magnetic saturation can be considered. However, substantially increasing the thickness dimension ly of the outer cylinder portion 18 lowers power output per unit weight and reduces power output density of the electric motor 10. To raise the power output per unit weight of the electric motor 10, it is preferable for the thickness dimension ly of the outer cylinder portion 18 to be small (thin). When the thickness dimension ly of the outer cylinder portion 18 is smaller, the electric motor 10 may be reduced in size compared to a structure in which the thickness dimension ly is larger, and the power output density may be improved.

A maximum thickness dimension lys of the outer cylinder portion 18 is a dimension such that a maximum magnetic flux density Bm caused by the field portion 16 in the outer cylinder portion 18 is a saturation magnetic flux density Bs. If the thickness dimension ly of the outer cylinder portion 18 exceeds the thickness dimension lys (ly>lys), magnetic saturation does not occur.

In contrast, when the thickness dimension ly of the outer cylinder portion 18 is equal to or less than the thickness dimension lys (ly<lys), magnetic saturation is likely to occur, and when the thickness dimension ly is less than the thickness dimension lys (ly<lys), magnetic saturation does occur. If the thickness (the radial direction dimension) of the outer cylinder portion 18 is very thin, harmonics (spatial harmonics) become significant in the gap between the field portion 16 and the outer cylinder portion 18 due to magnetic saturation. If spatial harmonics become significant in the gap between the field portion 16 and the outer cylinder portion 18, in which the coils 20U to 20W of the electric motor 10 are disposed, torque ripple tends to occur.

In the magnetic field generating portion 24 of the electric motor 10, the thickness dimension ly of the outer cylinder portion 18 is set to a dimension the same as the thickness dimension lys ( ly=lys) or the thickness dimension ly is made a little smaller than the thickness dimension lys. Consequently, the electric motor 10 may be reduced in size while torque ripple due to the thickness dimension ly of the outer cylinder portion 18 may be suppressed.

If the outer cylinder portion 18 is a magnetic material with low (small) magnetic permeability such that a magnetic flux density in the magnetic field produced by the field portion 16 does not reach the residual magnetic flux density of the permanent magnets 22 if the gap length G between the surface opposing the field portion 16 and the surface of the field portion 16 were zero, magnetic leakage (magnetic flux leakage) occurs.

However, in the outer cylinder portion 18 of the magnetic field generating portion 24, a high-permeability ferromagnetic material (a magnetic material with high magnetic permeability) is used that provides a magnetic flux density in the magnetic field produced by the field portion 16 of at least the saturation magnetic flux density of the permanent magnets 22 if the gap length G between the surface opposing the field portion 16 and the surface of the field portion 16 were zero. Therefore, in the magnetic field generating portion 24, magnetic leakage (magnetic flux leakage) at the outer cylinder portion 18 is suppressed, a magnetic field corresponding to a dual Halbach array field system may be formed effectively between the field portion 16 and the outer cylinder portion 18, and torque ripple due to the thickness dimension ly of the outer cylinder portion 18 may be suppressed more effectively.

In the field portion 16 of the electric motor 10 employing the Halbach magnet array, the magnetic pole number P is a multiple of two, and the number of sets m of the permanent magnets 22 is a multiple of two (P=2 m). In the electric motor 10 to which three-phase AC electric power is supplied, a slot number (the number of coils) S is a multiple of three. The power output of the electric motor 10 may be increased by increasing the magnetic pole number P and the slot number S.

In FIG. 1, substantial radial regions of each of the rotor 12 and stator 14 of the electric motor 10 are shown. In the electric motor 10, the magnetic pole number P is 16 (16 poles), and the slot number S is 18. Therefore, the magnetic pole number P relative to the slot number S in the electric motor 10 is eight per nine (P:S=8:9). Thus, in the electric motor 10, the magnetic pole number P has a value relative to the slot number S other than two per three (P:S=2:3) or four per three (P:S=4:3).

In the electric motor 10 that is structured thus, the magnetic field generating portion 24 is formed by the field portion 16 of the rotor 12 and the outer cylinder portion 18 of the stator 14, and the armature 20 (the coils 20U to 20W) is disposed in the magnetic field generating portion 24. Therefore, when three-phase AC electric power at a predetermined voltage is supplied to each of the coils 20U to 20W of the electric motor 10, the rotor 12 is rotated and rotates the power output shaft. The rotor 12 rotates and the power output shaft is driven to rotate at a rotary speed depending on a frequency of the three-phase AC electric power supplied to each of the coils 20U to 20W.

In the magnetic field generating portion 24 of this electric motor 10, the field portion 16 is surrounded by the outer cylinder portion 18, the outer cylinder portion 18 opposes each of the permanent magnets 22 of the field portion 16, and the Halbach array field system 26 is formed by the plural permanent magnets 22 at the field portion 16. In the magnetic field generating portion 24, the outer cylinder portion 18 is disposed such that a position of the inner periphery face thereof relative to the field portion 16 is at a position corresponding to the gap center Gc of the Halbach array field systems 26A and 26B of the dual Halbach array field system 30. Therefore, a magnetic field the same (or a similar magnetic field) as if the dual Halbach array field system 30 were employed is formed between the field portion 16 and the outer cylinder portion 18 of the magnetic field generating portion 24.

In the dual Halbach array field system 30 (the magnetic field generating portion 34), the gap length 2G is set, such that a maximum number of magnetic flux interlinkage are formed at the gap center Gc, in the range from 0.5 times to 2.0 times the pole pitch τ (0.5τ≤2G≤2.0τ). In the electric motor 10, the gap length G is set in the range from 0.25 times to 1.0 times the pole pitch τ (0.25τ≤G≤1.0τ).

In the dual Halbach array field system 30 (the magnetic field generating portion 34), the characteristics of the dual Halbach array field system are obtained when the gap length 2G is in the range from 0.5 times to 2.0 times the pole pitch τ. Consequently, in the magnetic field generating portion 34, spatial harmonics are suppressed at the gap center Gc, and the magnetic flux density at the gap center Gc changes in a sinusoidal form in the circumferential direction, which is the electrical angle direction. Therefore, in the magnetic field generating portion 24, when the gap length G is in the range from 0.25 times to 1.0 times the pole pitch τ, spatial harmonics at positions at the gap length G are suppressed, and the magnetic flux density at positions at the gap length G changes in a sinusoidal form in the circumferential direction, which is the electrical angle direction.

The outer cylinder portion 18 is disposed at a suitable position relative to the field portion 16 such that the magnetic field generating portion 24 of the electric motor 10 may resemble the dual Halbach array field system 30. Thus, an effect of the dual Halbach array field system 30 in that torque ripple may be suppressed is suitably reproduced. Therefore, with the magnetic field generating portion 24 of the electric motor 10 using the single Halbach array field system 26, similar effects to the dual Halbach array field system 30 are provided, and torque ripple is suppressed in the electric motor 10.

In the electric motor 10, the thickness dimension ly of the outer cylinder portion 18 is set to be not more than the thickness dimension lys at which magnetic saturation occurs (ly≤lys). Therefore, because the thickness dimension ly of the outer cylinder portion 18 in the electric motor 10 is set smaller than a thickness dimension with which magnetic saturation does not occur, the size of the outer cylinder portion 18 may be reduced.

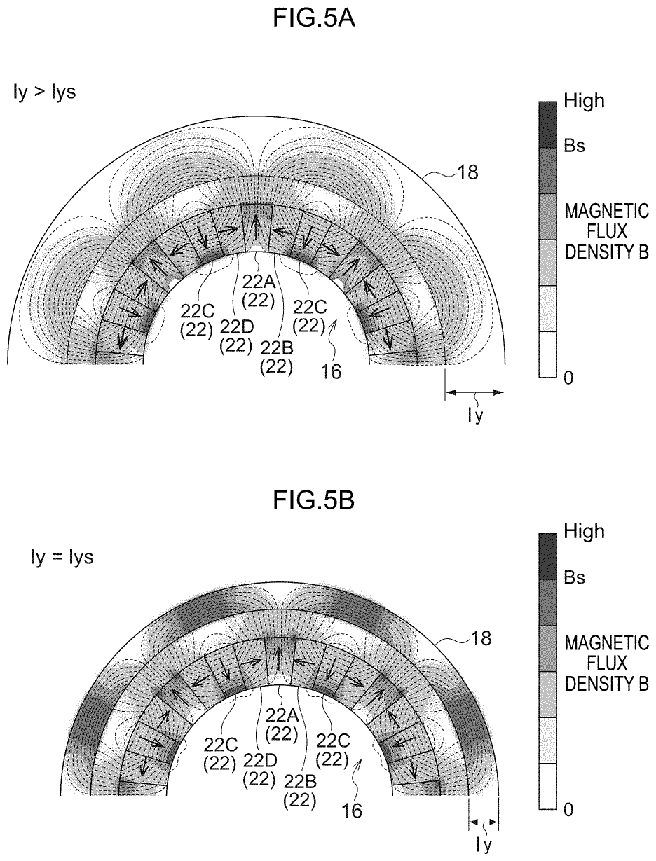

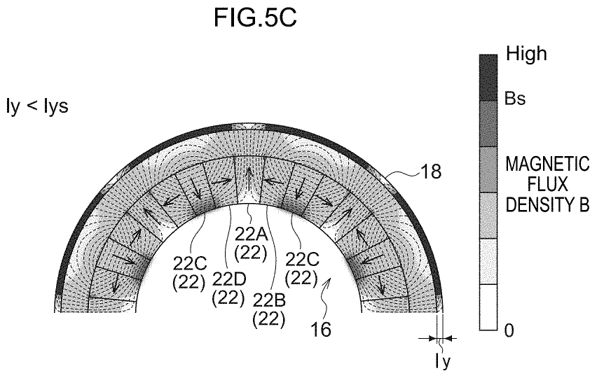

In FIG. 5A to FIG. 5C, distributions of magnetic force lines and distributions of magnetic flux density between the field portion 16 and outer cylinder portion 18 depending on thickness dimensions ly of the outer cylinder portion 18 are shown in schematic diagrams. FIG. 5A shows an example in which the thickness dimension ly is larger than the thickness dimension lys (ly>lys), FIG. 5B shows an example in which the thickness dimension ly is the same as the thickness dimension lys (ly=lys), and FIG. 5C shows an example in which the thickness dimension ly is smaller than the thickness dimension lys (ly<lys).

When the thickness dimension ly of the outer cylinder portion 18 is greater than the thickness dimension lys at which magnetic saturation occurs (ly>lys), as shown in FIG. 5A, magnetic saturation does not occur in the outer cylinder portion 18 and a magnetic flux density B in the outer cylinder portion 18 does not reach a saturation magnetic flux density Bs anywhere in the outer cylinder portion 18. Because magnetic saturation does not occur in the outer cylinder portion 18, spatial harmonics in the magnetic field generating portion 24 are suppressed. Therefore, although the outer diameter dimension of the outer cylinder portion 18 is larger, torque ripple is suppressed in the electric motor 10.

In contrast, when the thickness dimension ly of the outer cylinder portion 18 is less than or equal to the thickness dimension lys (ly<lys), as shown in FIG. 5B and FIG. 5C, magnetic saturation occurs in the outer cylinder portion 18. In a range in which the thickness dimension ly of the outer cylinder portion 18 is similar to the thickness dimension ly (ly=lys or ly≈lys), as shown in FIG. 5B, regions in which the magnetic flux density B reaches the saturation magnetic flux density Bs are circumferential direction portions (small regions) of the outer cylinder portion 18. When the thickness dimension ly of the outer cylinder portion 18 is smaller than the thickness dimension lys (ly<lys), as shown in FIG. 5C, regions of the outer cylinder portion 18 in which the magnetic flux density B is at the saturation magnetic flux density Bs are greater in the circumferential direction.

In the electric motor 10, the thickness dimension ly of the outer cylinder portion 18 is less than or equal to the thickness dimension lys. Thus, the outer diameter dimension of the outer cylinder portion 18 may be reduced. Therefore, the electric motor 10 may be reduced in size, and power output density may be improved. Because a magnetic field similar to the dual Halbach array field system 30 is formed between the field portion 16 and outer cylinder portion 18 in the electric motor 10, torque ripple may be suppressed compared to a structure in which a magnetic field similar to the dual Halbach array field system 30 is not formed.

However, if the thickness dimension ly of the outer cylinder portion 18 of the electric motor 10 is much smaller than the thickness dimension lys, regions of the outer cylinder portion 18 in which magnetic saturation occurs broaden in the circumferential direction. When regions of the outer cylinder portion 18 of the magnetic field generating portion 24 in which magnetic saturation occurs are broad in the circumferential direction, magnetic resistance on magnetic paths formed between the field portion 16 and outer cylinder portion 18 increases. When magnetic resistance on magnetic paths increases in the magnetic field generating portion 24, the effect of the method of images declines, spatial harmonics increase, and torque ripple increases in the electric motor 10 provided with the magnetic field generating portion 24.

In this magnetic field generating portion 24, a Halbach magnet array (the Halbach array field system 26) is employed at the field portion 16. Therefore, torque ripple in the magnetic field generating portion 24 due to magnetic saturation occurring at the outer cylinder portion 18 is suppressed in accordance with the method of images.

In the magnetic field generating portion 24, the coils 20U to 20W are respectively formed as air-core coils. Therefore, electric permittivity between the field portion 16 and outer cylinder portion 18 is substantially the same as the permittivity of air, and harmonics of magnetic flux forming interlinking with the coils 20U to 20W are suppressed. Therefore, even if magnetic resistance on magnetic paths in the outer cylinder portion 18 of the magnetic field generating portion 24 increases, an increase in overall magnetic resistance of magnetic paths may be suppressed. Thus, even though the thickness dimension ly of the outer cylinder portion 18 of the magnetic field generating portion 24 is the thickness dimension lys or less, an increase in spatial harmonics may be suppressed, and an increase in torque ripple occurring in the electric motor 10 may be suppressed.

Therefore, because the thickness dimension ly of the outer cylinder portion 18 is not more than the thickness dimension lys (ly≤ys), the electric motor 10 may be reduced in size. In particular, the electric motor 10 may be further reduced in size by making the thickness dimension ly smaller than the dimension lys (ly<lys). When the thickness dimension ly in the electric motor 10 is close to the thickness dimension lys (ly≈lys), an increase in torque ripple and the like may be suppressed effectively.

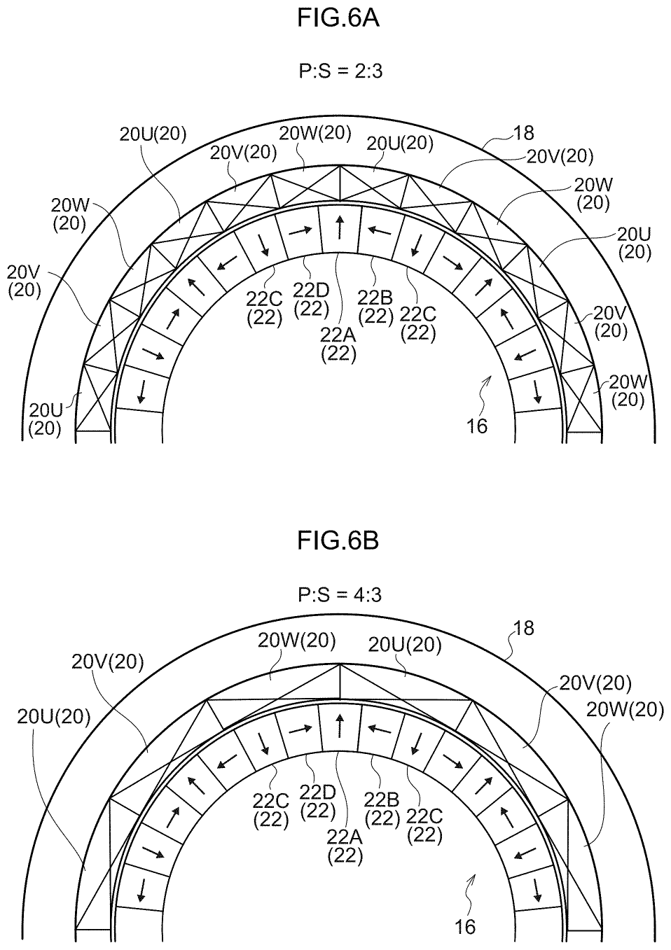

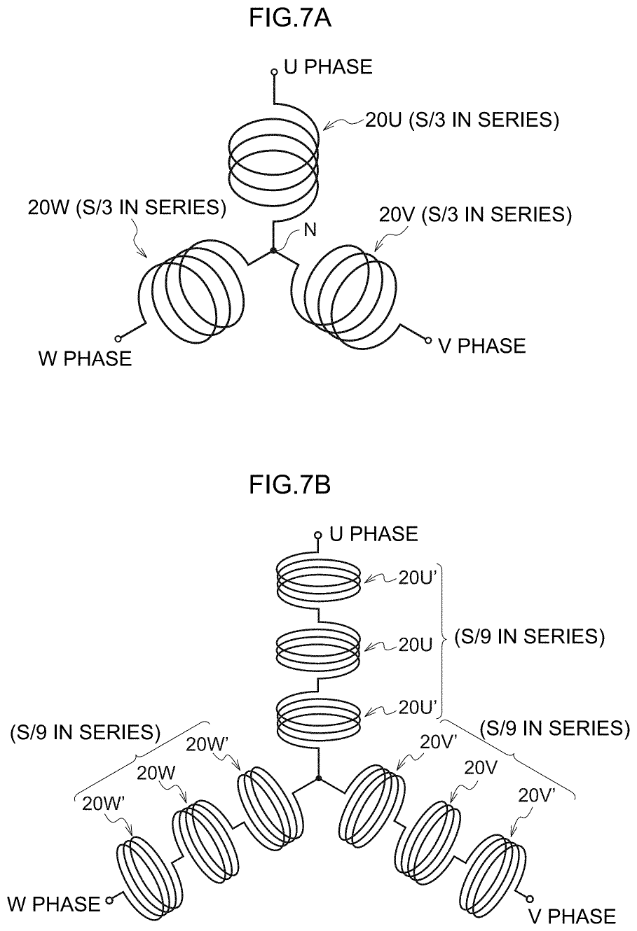

Meanwhile, the magnetic pole number P relative to the slot number S (P:S) in the electric motor 10 is 8:9. FIG. 6A and FIG. 6B illustrate combinations of P and S other than 8:9 in schematic diagrams. FIG. 7A and FIG. 7B illustrate connections of the coils 20U to 20W of the armature 20 of the electric motor 10 in single-line wiring diagrams. FIG. 6A shows an example in which the magnetic pole number P relative to the slot number S (P:S) is 2:3, and FIG. 6B shows an example in which the magnetic pole number P relative to the slot number S is 4:3.

As shown in FIG. 7A, one end of each phase of the coils 20U to 20W is connected to a neutral point N, and each individual phase of the coils 20U to 20W is connected in series. Therefore, when the slot number S is 18 (S=18), six of the coils 20U, 20V or 20W are connected in series for each phase. When the slot number S is 24 (S=24), eight of the coils 20U, 20V or 20W are connected in series for each phase, and when the slot number S is 12 (S=12), four of the coils 20U, 20V or 20W are connected in series for each phase.

The coils 20U, 20V and 20W each have concentrated windings, which are arranged along the whole circumference of the outer cylinder portion 18 in the circumferential direction in the sequence coil 20U, coil 20V, coil 20W, coil 20U, etc. (see FIG. 1, FIG. 6A and FIG. 6B).

The arrangement of the armature 20 along the circumferential direction of the outer cylinder portion 18 is not limited thus. An example in which the slot number S is a multiple of nine is illustrated in FIG. 7B.

As shown in FIG. 7B, reverse windings of the coils 20U, 20V and 20W are, respectively, coils 20U′, 20V′ and 20W′. For each of the U phase, V phase and W phase, the reverse-winding coils 20U′, 20V′ and 20W′ are connected in series at both sides of each of the forward-winding coils 20U, 20V and 20W. For example, for the U phase, the coil 20U′, coil 20U and coil 20U′ are connected in series to form a set. When the slot number is 18, the U phase is wired by connecting two of the sets of the coil 20U′, coil 20U and coil 20U′ in series. The V phase and the W phase are wired in the same way as the U phase, using the respective coils 20V and 20V′ and coils 20W and 20W′.

The coils 20U to 20W and 20U′ to 20W′ of the armature 20 with respective concentrated windings are arranged at the outer cylinder portion 18 in the sequence coil 20U, coil 20U′, coil 20V′, coil 20V, coil 20V′, coil 20W′, coil 20W, coil 20W′, coil 20U′, etc. The wiring in FIG. 7B may be employed for the wiring of the armature 20 of the electric motor 10.

As illustrated in FIG. 6A, if the magnetic pole number P is 16 and P:S is 2:3, then the slot number is 24 (the number of coils is 24) and eight sets of the coils 20U, 20V and 20W are sequentially arranged in the circumferential direction. As illustrated in FIG. 6B, if the magnetic pole number P is 16 and P:S is 4:3, then the slot number is 12 (the number of coils is 12), and four sets of the coils 20U, 20V and 20W are sequentially arranged in the circumferential direction.

When the thickness dimension ly of the outer cylinder portion 18 is small (for example, a yoke is thin), maximum-amplitude portions of the sinusoidal magnetic flux forming interlinkage with the coils 20U to 20W are flattened (distorted) by magnetic saturation in the outer cylinder portion 18, and a third harmonic and fifth harmonic are manifested strongly. The third harmonic is a frequency component at three times the power supply frequency. Therefore, when the coils are driven by a three-phase AC power supply, the occurrence of significant torque ripple is suppressed. However, the fifth harmonic is significant as torque ripple with a frequency component at six times the power supply frequency.

When the field portion 16 employing the Halbach magnet array rotates and magnetic flux density in the outer cylinder portion 18 is close to saturation, the fifth spatial harmonic of a magnetic flux density distribution that is produced in the gap (in the air between the field portion 16 and outer cylinder portion 18) forms interlinkage with the coils 20U to 20W of each phase. Therefore, induced electromotive forces are generated at a frequency six times the power source frequency. Because sinusoidal currents in the coils 20U to 20W flow from the AC power supply in opposition to the induced electromotive forces, torque ripple at a frequency of six times the power supply frequency is produced in the coils 20U to 20W of the respective phases. Therefore, to suppress this torque ripple, it is desirable for the total number of magnetic flux interlinkage of the fifth spatial harmonic forming interlinkage with the coils 20U to 20W of the respective phases to be small.

For simplicity, the amplitude of the fifth spatial harmonic of the magnetic flux density distribution in the gap is represented as 1, and the coils 20U to 20W are wound with coil widths (coil widths in the circumferential direction) that meet at the boundaries shown in each of FIG. 1, FIG. 6A and FIG. 6B.

A (change over time in a) total number of magnetic flux interlinkage of the fifth spatial harmonic in, for example, the coils 20U of the U phase, ψ(ωt), is expressed by expressions (14) to (16). In expressions (14) to (16), x represents mechanical angle (rotation angle of the power output shaft) ω represents driving angular velocity, and t represents time.

The term ψ_{2to 3}(wt) in expression (14) represents the structure in which the magnetic pole number P is 16 and the slot number S is 24 (P:S is 2:3), the term ψ_{4to 3}(ωt) in expression (15) represents the structure in which the magnetic pole number P is 16 and the slot number S is 12 (P:S is 4:3), and the term ψ_{8to 9} (ωt) in expression (16) represents the structure in which the magnetic pole number P is 16 and the slot number S is 18 (P:S is 8:9).

$${ψ}_{2 to 3} ( ω t ) = 8 {\int }_{- \frac{π}{{N}_{s}}}^{\frac{π}{{N}_{s}}} cos ( 5 \frac{{N}_{p}}{2} x + ω t ) dx \qquad ( 14 )$$

$$( ∵ {N}_{p} = 16 , {N}_{s} = 24 )$$

$${ψ}_{4 to 3} ( ω t ) = 4 {\int }_{- \frac{π}{{N}_{s}}}^{\frac{π}{{N}_{s}}} cos ( 5 \frac{{N}_{p}}{2} x + ω t ) dx \qquad ( 15 )$$

$$( ∵ {N}_{p} = 16 , {N}_{s} = 12 )$$

$${ψ}_{8 to 9} ( ω t ) = 2 {\int }_{- \frac{π}{{N}_{s}} - \frac{2 π}{{N}_{s}}}^{\frac{π}{{N}_{s}} - \frac{2 π}{{N}_{s}}} - cos ( 5 \frac{{N}_{p}}{2} x + ω t ) dx + 2 {\int }_{- \frac{π}{{N}_{s}}}^{- \frac{π}{{N}_{s}}} cos ( 5 \frac{{N}_{p}}{2} x + ω t ) dx + 2 {\int }_{- \frac{π}{{N}_{s}} + \frac{2 π}{{N}_{s}}}^{\frac{π}{{N}_{s}} + \frac{2 π}{{N}_{s}}} - cos ( 5 \frac{{N}_{p}}{2} x + ω t ) dx \qquad ( 16 )$$

$$( ∵ {N}_{p} = 16 , {N}_{s} = 18 )$$

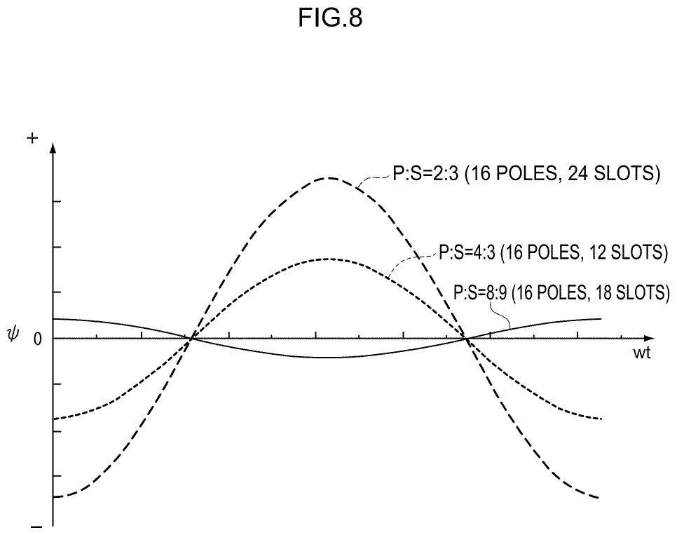

FIG. 8 shows graphs of changes over time (ωt) of the total number of magnetic flux interlinkage (ψ) of the fifth spatial harmonic in the coils 20U between the U phase and the neutral point N. The graphs are obtained by each of the expressions (14) to (16). The negative side of the vertical axis represents the direction of magnetic force lines in sum being in the opposite direction to the direction of the positive side.

As shown in FIG. 8, when P:S is 2:3, the number of magnetic flux interlinkage of the fifth spatial harmonic is greater than when P:S is 4:3 or 8:9. When P:S is 4:3, the number of magnetic flux interlinkage of the fifth spatial harmonic in the magnetic flux density distribution in the gap is half the number when P:S is 2:3. Further, when P:S is 8:9, the total number of magnetic flux interlinkage of the fifth spatial harmonic in the magnetic flux density distribution in the gap is very small.

Accordingly, in order to suppress torque ripple due to the thickness dimension ly of the outer cylinder portion 18 opposing the field portion 16 being made small (ly≤lys), it is preferable for P:S to have a value other than 2:3, and even more preferable for P:S to have a value other than 2:3 or 4:3.

Therefore, in the electric motor 10 in which P:S is 8:9, obviously when the thickness dimension ly of the outer cylinder portion 18 is the same as the dimension lys (ly=lys), and also when the thickness dimension ly is smaller than the thickness dimension lys (ly<lys), torque ripple caused by magnetic saturation in the outer cylinder portion 18 may be suppressed effectively even while power output density is improved.

As described above, in a three phase induction motor, of spatial harmonics included in the magnetic flux density over a full cycle of electrical angles, torque ripple that is caused by spatial harmonics of orders that are multiples of three (the third, sixth, etc.) is suppressed. The amplitudes of spatial harmonics also influence torque ripple. Among spatial harmonics, the amplitudes of lower order spatial harmonics are greater than the amplitudes of higher order spatial harmonics. Therefore, it is the lower order spatial harmonics that influence torque ripple.

In a field system employing a Halbach magnet array, the division number m of the permanent magnets 22 is determined from the division number n over a full cycle of electrical angles. Changes in magnetic flux density in a magnetic field (changes in the electrical angle direction) incorporate spatial harmonics. The amplitude of a spatial harmonic of the order (pn+1), whose order number is 1 plus a multiple p of the division number n (p being a positive integer), is large. For example, if the division number n=4, the amplitudes of spatial harmonics of the fifth order (p=1) and the ninth order (p=2) are large.

Accordingly, it is more preferable if the division number n is n=3·k+2 (k being a positive integer). Therefore, in the electric motor 10 employing three-phase AC electric power, the production of spatial harmonics that influence torque ripple at the field portion 16 using the Halbach magnet array may be suppressed.

Therefore, in the electric motor 10, obviously when the thickness dimension ly of the outer cylinder portion 18 is the same as the thickness dimension lys (ly=lys), and also when the thickness dimension ly is smaller than the thickness dimension lys (ly<lys), it is preferable if the division number n of the Halbach magnet array of the field portion 16 is set to n=3·k+2 (k being a positive integer). Thus, the electric motor 10 may suppress an increase in spatial harmonics even while improving power output density, and may suppress torque ripple caused by magnetic saturation effectively.

By combining the magnetic pole number P with the slot number S and combining that combination with the division number n=·k+2 (in which k is a positive integer), the electric motor 10 may suppress an increase in spatial harmonics more effectively and may suppress torque ripple caused by magnetic saturation more effectively.

Accordingly, the thickness dimension ly of the outer cylinder portion 18 in the electric motor 10 is made smaller (thinner) than or the same thickness as the thickness dimension lys at which magnetic saturation occurs. Therefore, the electric motor 10 may be reduced in size. Moreover, because spatial harmonics caused by magnetic saturation of the outer cylinder portion 18 are suppressed in the electric motor 10, torque ripple caused by spatial harmonics in the magnetic field, vibrations caused by cogging torque, noise caused by vibrations, and so forth may be suppressed. Thus, stable power output may be obtained even when the electric motor 10 is driven at high speed.

In the electric motor 10, the gap length G that is the spacing between the outer periphery face of the field portion 16 and the inner periphery face of the outer cylinder portion 18 is half of the gap length in the dual Halbach array field system 30 (the gap length 2G). Therefore, the number of magnetic flux interlinkage formed in each of the coils 20U to 20W disposed at the inner periphery face of the outer cylinder portion 18 of the electric motor 10 is half (substantially half) of the number of magnetic flux interlinkage in a duel Halbach array field system. Therefore, output torque of the electric motor 10 is half of output torque if the magnetic field generating portion 34 (the dual Halbach array field system 30) were employed with the same input current. However, counter-electromotive forces when the rotary speed of the electric motor 10 is increasing while producing the same torque as at the start of driving are around half of counter-electromotive forces if the magnetic field generating portion 34 were employed. Therefore, given the same power supply voltage, torque may be generated by the electric motor 10 up to a speed that is twice a speed if the dual Halbach array field system 30 (the magnetic field generating portion 34) were employed at the magnetic field generating portion 24, and the electric motor 10 provides power output equivalent to power output if the dual Halbach array field system 30 (the magnetic field generating portion 34) were employed at the magnetic field generating portion 24.

In an electric motor employing the magnetic field generating portion 34 (the dual Halbach array field system 30), the field portion 34B is provided at an outer rotor. Therefore, a casing (a cover body) must be provided outside the outer rotor at which the field portion 34B is provided.

In contrast, in the electric motor 10, the outer cylinder portion 18 is fixed opposing the field portion 16. Therefore, the outer cylinder portion 18 may be provided with the function of a casing. Hence, the electric motor 10 may be reduced in size and a number of components may be reduced, costs may be lowered, and power output density may be improved. Moreover, because a Halbach magnet array is used in the electric motor 10, the number of the permanent magnets 22 may be reduced compared to a structure employing a dual Halbach magnet array. Thus, weight may be further reduced and costs may be further lowered, and power output density may be improved effectively.

In general, among electrical machines whose radial direction cross sections have similar shapes and that have the same length in the axial direction, power output (torque) increases proportionally to the cube of the scale factor. The electric motor 10 has greater margin for size in the radial direction than a structure employing the dual Halbach array field system 30. Therefore, power output of the electric motor 10 may be increased, and the electric motor 10 may be expected to provide greater power output density (the ratio of power output to weight) than a structure employing the dual Halbach array field system 30.

In the electric motor 10, the coils 20U to 20W are formed as air-core coils and employ Litz wire. Because the coils 20U to 20W of the electric motor 10 are air-core coils, counter-electromotive forces may be suppressed, and heating of switching components in an inverter circuit performing inverter control may be suppressed. Because Litz wire is used for the windings of the coils 20U to 20W, inductance may be reduced, and heating and counter-electromotive forces produced at each of the coils 20U to 20W may be suppressed effectively. Therefore, a rated rotary speed of the electric motor 10 may be raised and the electric motor 10 may run faster.

In the electric motor 10, the outer cylinder portion 18 at which the armature 20 (the coils 20U to 20W) is disposed does not rotate. Therefore, cooling means such as a cooling fan, cooling pipes or the like may be used to cool the outer cylinder portion 18, and the armature 20 at the inner side of the outer cylinder portion 18 may be cooled together with the outer cylinder portion 18. Consequently, the electric motor 10 may suppress heating effectively, and may output large torques for short durations.

In the exemplary embodiment described above, for an example in which the division number n of the field portion 16 is 4, a division number n that is n=3·k+2 (in which k is a positive integer) is described as being more preferable. However, it is sufficient for the division number n to be an integer that is at least 3.

In the present exemplary embodiment, the electric motor 10 is described as an example. However, a rotating electrical machine may be used that operates as a drive source for a power running mode of a vehicle and that operates as a regenerating generator in a low speed mode (a regeneration mode). In this situation, even though the direction of current is reversed in switching between the power running mode and the regeneration mode, magnetic energy accumulating at the armature may be suppressed (reduced). Therefore, induced voltages produced in the rotating electrical machine at times of current switching may be lowered, and damage by the rotating electrical machine to a driving circuit that drives the rotating electrical machine may be suppressed. Moreover, the rotating electrical machine may provide driving characteristics of the vehicle with excellent response.

In the present exemplary embodiment, the field portion 34B at the radial direction outer side of the field portions 34A and 34B is replaced with a ferromagnetic body (the outer cylinder portion 18). However, in a magnetic field generating device used in a rotating electrical machine, the Halbach magnet array at the radial direction inner side may be replaced with a ferromagnetic body, and a field caused by a Halbach magnet array may be arranged at the radial direction outer side of this ferromagnetic body.

In the present exemplary embodiment, the electric motor 10 is described as an example in which the outer cylinder portion 18 of the stator 14 is disposed so as to surround the rotor 12 at which the permanent magnets 22 are arranged in an annular shape. However, a rotating electrical machine may be arranged with a field portion in which permanent magnets are arranged in an annular shape surrounding a cylinder body being relatively rotatable.

In the present exemplary embodiment, the electric motor 10 is described as an example. However, the rotating electrical machine may be a generator that generates three-phase AC electric power when rotated. When a generator is employed as the rotating electrical machine, output power density of the generator may be improved.

The disclosures of Japanese Patent Application No. 2019-155987 are incorporated into the present specification by reference in their entirety. All references, patent applications and technical specifications cited in the present specification are incorporated by reference into the present specification to the same extent as if the individual references, patent applications and technical specifications were specifically and individually recited as being incorporated by reference.

1. A rotating electrical machine comprising:
a field portion including a plurality of permanent magnets arranged in an annular shape in a circumferential direction, with magnetization directions thereof being successively changed in steps of an angle that is equal to an electrical angle of a full cycle divided by a division number n, the division number n being any one integer that is at least three;
a cylinder body that is formed in an annular shape opposing each of the permanent magnets and is relatively rotatable with respect to the field portion, a ferromagnetic material being used in the cylinder body, a central axis of the cylinder body coinciding with a central axis of the field portion, and a radial direction dimension of the cylinder body being a dimension such that magnetic flux density inside the cylinder body of a magnetic field caused by the field portion reaches a saturation magnetic flux density; and
an armature in which three-phase coils are arranged in the circumferential direction at a face of the cylinder body at the side thereof at which the field portion is disposed, each coil being an air-core coil, wherein a magnetic pole number P of the field portion and a slot number S are specified such that a fifth spatial harmonics of a magnetic flux interlinking with a coil is smaller than the fifth spatial harmonics of the magnetic flux interlinking with the coil in a case in which the magnetic pole number P is two thirds of the slot number S, the slot number S being a number of the coils of the armature.

2. The rotating electrical machine according to claim 1, wherein a dimension of the cylinder body is configured such that:
a magnetic flux density obtained in the magnetic field caused by the field portion is at least a residual magnetic flux density, the residual magnetic flux density being a magnetic flux density of the permanent magnets in a case in which a gap length between a surface opposing the field portion and a surface of the field portion is zero, and
with a predetermined gap length, the magnetic flux density reaches the saturation magnetic flux density.

3. The rotating electrical machine according to claim 1, wherein the field portion is provided at a rotor, and the cylinder body serves as a stator and surrounds an outer periphery of the field portion.

4. The rotating electrical machine according to claim 1, wherein a radial direction dimension of the cylinder body is a maximum dimension at which the magnetic flux density is the saturation magnetic flux density.

5. The rotating electrical machine according to claim 1, wherein the magnetic pole number P of the field portion and the slot number S that is the number of coils of the armature are specified such that the fifth spatial harmonics of the magnetic flux interlinking with the coil is smaller than the fifth spatial harmonics of the magnetic flux interlinking with the coil in a case in which the magnetic pole number P is four thirds of the slot number S.

6. The rotating electrical machine according to claim 1, wherein the division number n is a number obtained by adding 2 to a multiple of 3.

7. The rotating electrical machine according to claim 1, wherein a gap length that is a spacing between surfaces of the field portion and the cylinder body that faces each other is at least 0.25 times and at most 1.0 times a pole pitch τ of the permanent magnets of the field portion.
